(19) United States
(12) Patent Application Publication
(10) Pub. No.: US 2019/0291298 A1
(43) Pub. Date: Sep. 26, 2019

(54) BARK REMOVAL APPARATUS FOR CHIPPING MACHINE

(71) Applicant: Astec Industries, Inc., Chattanooga, TN (US)

(72) Inventors: Nathan Anderson, Eugene, OR (US); Douglas Bulkeley, Eugene, OR (US)

(73) Assignee: Astec Industries, Inc., Chattanooga, TN (US)

(21) Appl. No.: 16/299,662

(22) Filed: Mar. 12, 2019

Related U.S. Application Data
(60) Provisional application No. 62/645,523, filed on Mar. 20, 2018.

(51) Int. Cl. B27L 1/10; B27L 11/00

(52) U.S. Cl. CPC B27L 1/10; B27L 11/002

(57) ABSTRACT

An apparatus for use in debarking logs that includes a debarking assembly for separating bark from logs as the logs are passed through the apparatus, such that the separated bark falls away from the logs. A contact surface catches falling bark that has been separated from logs by the debarking assembly. A pusher reciprocates over the contact surface and includes a first pusher face that pushes bark over the contact surface. A magnet reciprocates with the pusher and may be selectively activated and deactivated. When the magnet is activated, a magnetic field is provided proximate the first pusher face such that magnetically attracted portions in the bark that are brought within the magnetic field as the pusher reciprocates are magnetically attracted to the first pusher face by the magnetic field and are separated from the bark.

### CROSS-REFERENCE TO RELATED APPLICATIONS

This application claims the benefit of U.S. Provisional Patent Application No. 62/645,523, filed on Mar. 20, 2018, and entitled BARK REMOVAL ASSEMBLY FOR CHIPPING MACHINE, which is incorporated herein by reference in its entirety.

### FIELD

The invention relates generally to devices for removing the bark and small limbs from logs, and more particularly, to a bark removal assembly that is adapted to remove flail chain components from the bark product.

### BACKGROUND

The processing of logs into wood chips requires an apparatus to remove the bark and limbs from the logs and an apparatus to reduce the partially processed logs into chips. Bark is considered to be a contaminant in the chips, so it is desirable to completely remove all bark prior to the chipping process. Debarking assemblies frequently comprise two or more rotating shafts to which are attached multiple flails, and it is common for the debarking assembly to be combined with the log chipper. Logs are introduced into the space between the shafts of the debarking assembly in a direction normal to the axes of rotation of the shafts. Typically, the shafts are arranged so that at least one is an upper shaft and another is a lower shaft, although they may be laterally offset from each other. In such a device, the feed line along which the logs are passed through the machine is located between an upper shaft and a lower shaft. In order to remove the bark and limbs from the log, at least some of the flails on the upper shaft should reach down along the sides of the log to at least the mid-point. Similarly, at least some of the flails on the lower shaft should reach upwardly along the sides of the log to the mid-point. The length of the flails on each shaft is dictated by the size of the smallest log that is intended to be debarked.

Bark that is removed from the logs by debarking assemblies is removed separately from the wood chips. However, while the bark is considered to be a contaminant in the chips, it can be used as mulch or as a fuel. Most commonly, flails are comprised of chains comprised of a plurality of interconnected iron or steel links. These flails may be thirty-six inches long or longer, and are mounted close together. During the debarking operation, the flails will beat against the logs, and sometimes, individual chain links or pieces of flail chain will break off in the process. If chain components fall with the bark from the machine, they will be included in the bark product.

What is needed is a mechanism that can easily separate chain and other similar components from the bark product.

### NOTES ON CONSTRUCTION

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “coupled”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The terms “operatively connected” and “operatively attached” describe such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity. Several terms are specifically defined herein. These terms are to be given their broadest reasonable construction consistent with such definitions, as follows:

The term “magnet” refers to a material or object that produces a magnetic field sufficient to attract ferromagnetic materials such as iron.

The term “linear actuator” refers to an electric, pneumatic, hydraulic, electro-hydraulic or mechanical device that generates force which is directed in a straight line. One common example of a “linear actuator” is a hydraulic or pneumatic actuator which includes a cylinder, a piston within the cylinder, and a rod attached to the piston. By increasing the pressure within the cylinder on one side of the piston (over that on the opposite side of the piston), the rod will extend from the cylinder or retract into the cylinder.

The term “flowable material” refers to solid particulate matter that can be poured or that flows, that can be gathered or piled, and that can also be pushed. Non-limiting examples of flowable material include bark, wood chips, rock, gravel, sand, etc.

The term “magnetically attracted” means capable of being attracted by the presence a magnetic field, including attracted or repelled by the magnetic field. The term “non-magnetically attracted” means not being attracted or repelled by the presence of a magnetic field.

### SUMMARY

The above and other needs are met by a pusher apparatus for pushing a flowable material that has fallen onto a contact surface over that contact surface and for selectively separating a magnetically attracted portion of the flowable material from a non-magnetically attracted portion of the flowable material as the flowable material is pushed. The pusher apparatus includes a pusher configured to reciprocate over said contact surface. Preferably, a low-friction slider is disposed on a bottom surface of the pusher and is configured to slide over the contact surface as the pusher reciprocates. A first pusher face is located on the pusher and is configured to push flowable material located on the contact surface over the contact surface as the pusher travels in a first direction. Preferably, the first pusher face is approximately perpendicular to the contact surface. A first magnet reciprocates with the pusher and may be selectively activated and deactivated. According to certain embodiments, the pusher apparatus forms an enclosure, the first pusher face is located on a side surface of the enclosure, and the magnet is disposed within an internal space located within the enclosure.

When the first magnet is activated, a first magnetic field is provided proximate the first pusher face such that magnetically attracted portions of the flowable material that are brought within the first magnetic field as the pusher reciprocates are magnetically attracted to the first pusher face by the magnetic field and are separated from the non-magnetically attracted portions of the flowable material. In some embodiments, the first magnet comprises a plurality of magnets disposed along the length of the first pusher face. In certain cases, each of the plurality of magnets may be activated and deactivated independently from one another.

According to certain embodiments, the first magnet is a permanent magnet. The first magnet is preferably disposed adjacent the first pusher face opposite the flowable material such that the first pusher face is located between the first magnet and the flowable material. The magnet is preferably pivotally mounted adjacent the first pusher face and is deactivated by pivoting away from the first pusher face. The pivoting first magnet may be operatively mounted to a hinge that enables the first magnet to pivot between the activated and deactivated positions. In that case, a linear actuator may be provided to pivot the first magnet about the hinge. In other cases, the first magnet is an electromagnet that may be activated and deactivated by providing or not providing electrical current.

In some embodiments, the pusher apparatus also includes a second pusher face that is located opposite the first pusher face. The second pusher face is configured to push flowable material disposed on the contact surface over the contact surface as the pusher travels in a second direction. A second magnet reciprocates with the pusher and may also be selectively activated and deactivated. When activated, the second magnet provides a second magnetic field proximate the second pusher face such that magnetically attracted portions of the flowable material that are brought within the second magnetic field as the pusher reciprocates are magnetically attracted to the second pusher face by the second magnetic field and are separated from the non-magnetically attracted portions of the flowable material. Preferably, the first and second magnets may activated and deactivated independently of one another.

In some cases, the pusher is provided as part of an apparatus for use in debarking logs. In addition to the pusher, the debarking apparatus includes a debarking assembly for separating bark from logs as the logs are passed through the debarking apparatus, such that the separated bark falls away from the logs. A contact surface is provided for catching falling bark that has been separated from logs by the debarking assembly. The pusher reciprocates over the contact surface and a first pusher face located on the pusher pushes bark located on the contact surface over the contact surface as the pusher travels in a first direction. A first magnet reciprocates with the pusher and may be selectively activated and deactivated. When activated, the first magnet provides a first magnetic field proximate the first pusher face such that magnetically attracted portions in the bark that are brought within the first magnetic field as the pusher reciprocates are magnetically attracted to the first pusher face by the first magnetic field and are separated from the bark. The debarking assembly may be a flail assembly having at least one flail. In that case, at least a portion of the magnetically attracted portion may include broken away portions of the at least one flail that have fallen with the separated bark onto the contact surface. In some cases, the debarking apparatus may be configured to process logs in a processing direction D and the pusher may reciprocate over the contact surface in a direction R₁ that is substantially parallel with processing direction D. In other cases, the debarking apparatus may be configured to process logs in a processing direction D and the pusher may reciprocate over the contact surface in a direction R₂ that is substantially perpendicular to processing direction D.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 is a side elevation view, partially in section, depicting a combination flail assembly and log chipping machine that is equipped with a bark pusher according to an embodiment of the present invention;

FIG. 2 is a top perspective view of a bark pusher according to an embodiment of the present invention;

FIG. 3 is a bottom plan view of the bark pusher shown in FIG. 2;

FIG. 4 is a sectional view taken along the line A-A of FIG. 3;

FIG. 5 is an enlarged view of a magnet and linear actuator mounted to a bark pusher in a deactivated position according to an embodiment of the present invention;

FIG. 6 illustrates the magnet and linear actuator of FIG. 5 in an activated position according to an embodiment of the present invention;

FIG. 7 is an elevation view illustrating bark falling onto a portion of a flail assembly and adjacent a two-sided bark pusher having a plurality of magnets according to an embodiment of the present invention;

FIG. 8 is a sectional view taken along the line B-B of FIG. 7 illustrating piles of bark located on opposite sides of the two-sided bark pusher; and

FIG. 9 is an elevation view, partially in section, illustrating a flail assembly having a bark pusher according to an alternative embodiment of the present invention.

### DETAILED DESCRIPTION

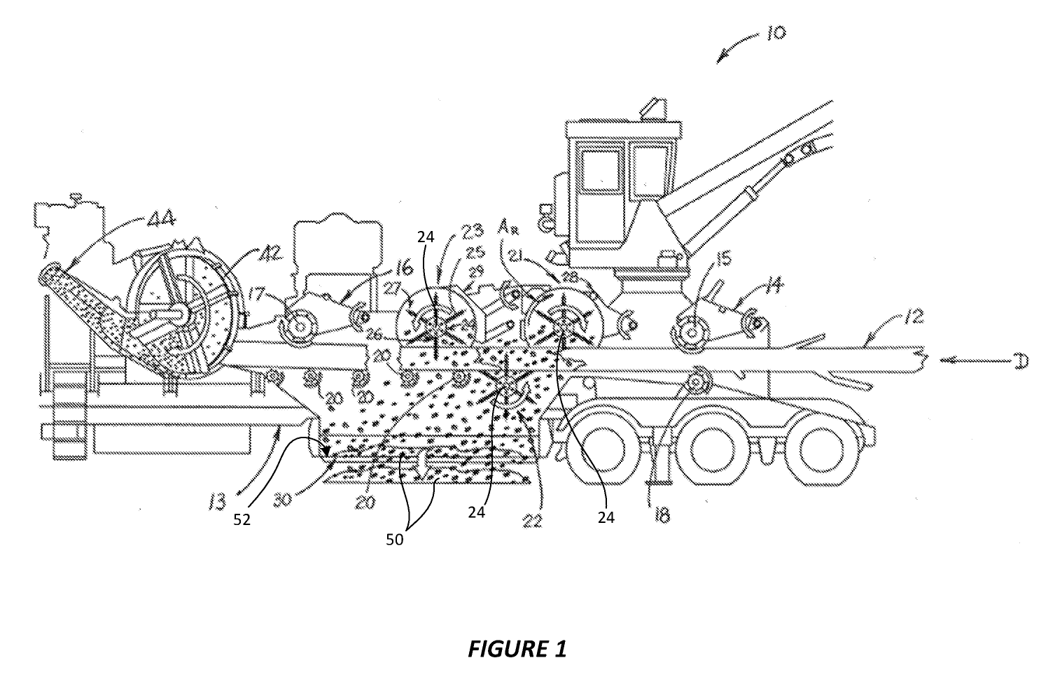

Referring now to FIG. 1, there is provided an apparatus 10 (also referred to herein as a log chipping machine) for use in debarking logs that includes a combination flail assembly and log chipping machine that is adapted to process logs 12. When the machine 10 is in operation, the log 12 is carried through the machine in processing direction D by contact with a plurality of rotating feed rolls. Upper feed roll assemblies 14 and 16 are pivotally mounted on the frame 13 of the machine 10 above the log 12 and are adapted to rotate feed rolls 15 and 17, respectively, in a clockwise direction (as shown in FIG. 1). Lower feed rolls 18 and 20 are mounted below the log 12 and are adapted to rotate in a counterclockwise direction (as shown in FIG. 1). Upper feed roll 15 and lower feed roll 18 cooperate to move log 12 into contact with debarking assemblies 21, 22 and 23. Each of the debarking assemblies 21, 22 and 23 includes a rotating shaft 24 to which are attached a plurality of flail chains 25. Each rotating shaft 24 rotates about an axis of rotation that is perpendicular to the direction D. Each flail chain 25 is comprised of a plurality of interconnected links and has a fixed end 26 that is attached to a shaft 24 and a free end 27 opposite the fixed end. Each flail chain 25 is of a length that defines an arc of rotation A_{R} of the free end 27 of the flail chain 25. The shaft 24 of first upper debarking assembly 21 rotates in a clockwise direction, while the shafts of lower debarking assembly 22 and second upper debarking assembly 23 rotate in a counterclockwise direction. Upper debarking assemblies 21 and 23 include housings 28 and 29, respectively, which are pivotally mounted to the frame of machine 10.

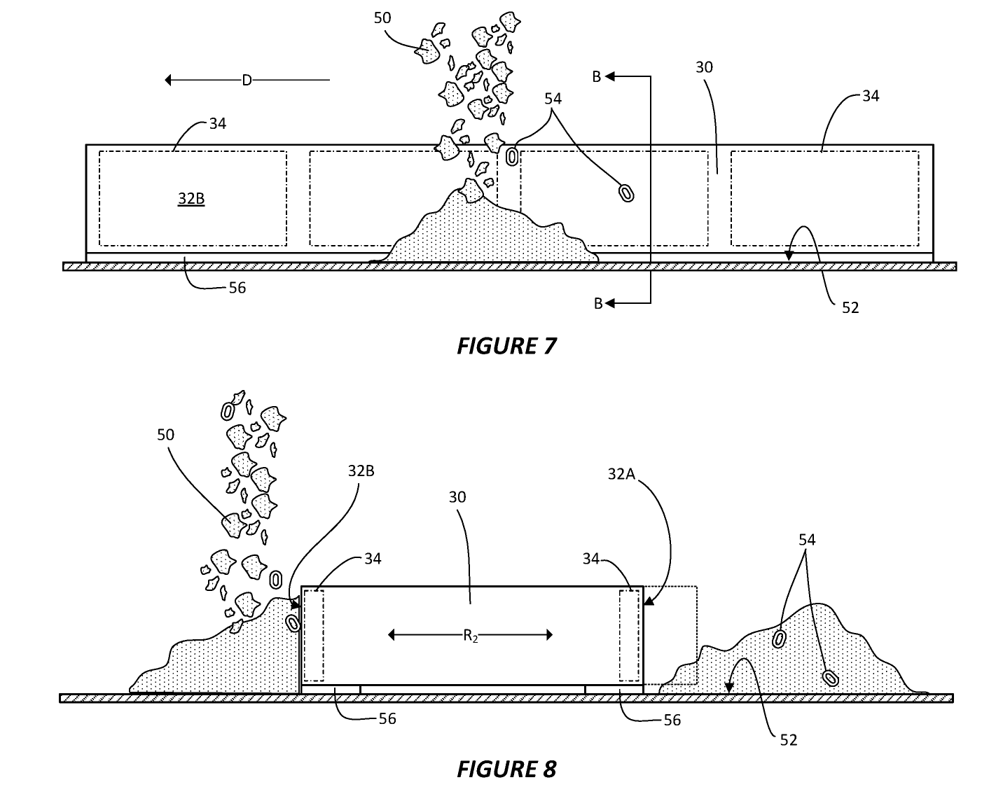

Rotation of the shafts 24 causes the chains 25 to flail the bark from the log 12 and to form a stream of falling flowable material 50. The flowable material 50 may include both non-magnetically attracted portions, such as tree bark, as well as magnetically attracted portions, such as broken flail chain components 54 (shown in FIGS. 7 and 8). At least a portion of the flowable material 50, including bark that is removed by the flail assemblies 21, 22, and 23, falls past a bark pusher apparatus 30 and is deposited onto a contact surface 52 of the chipping machine 10 adjacent the pusher apparatus.

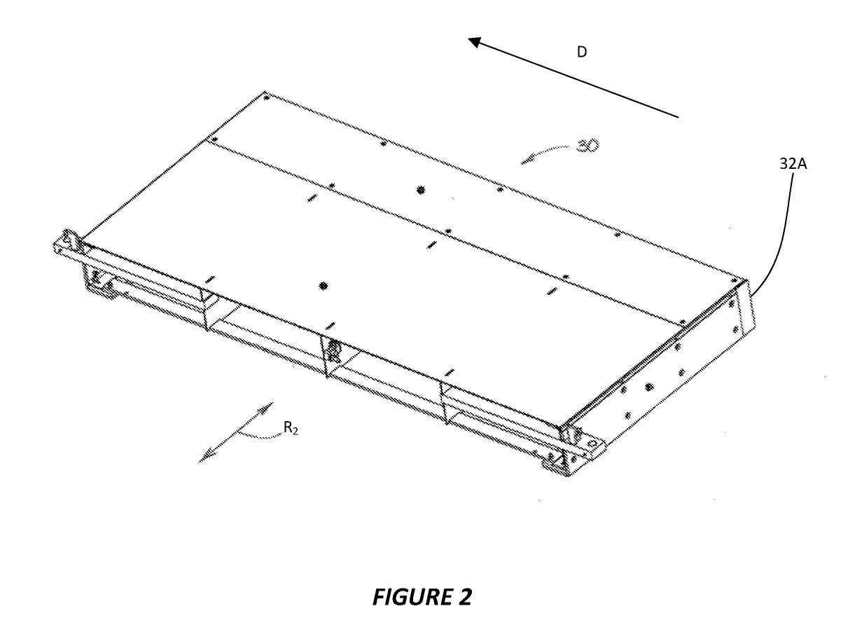

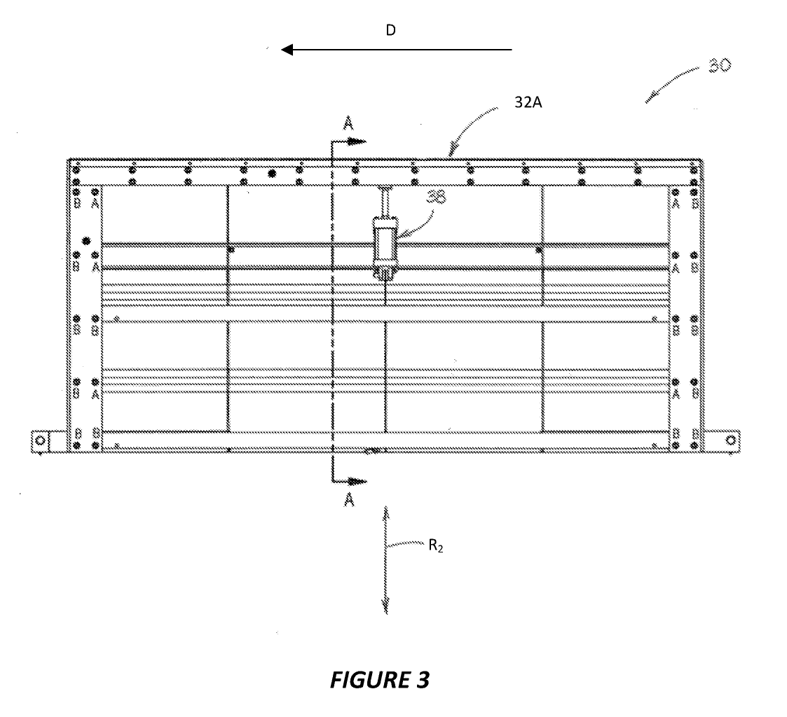

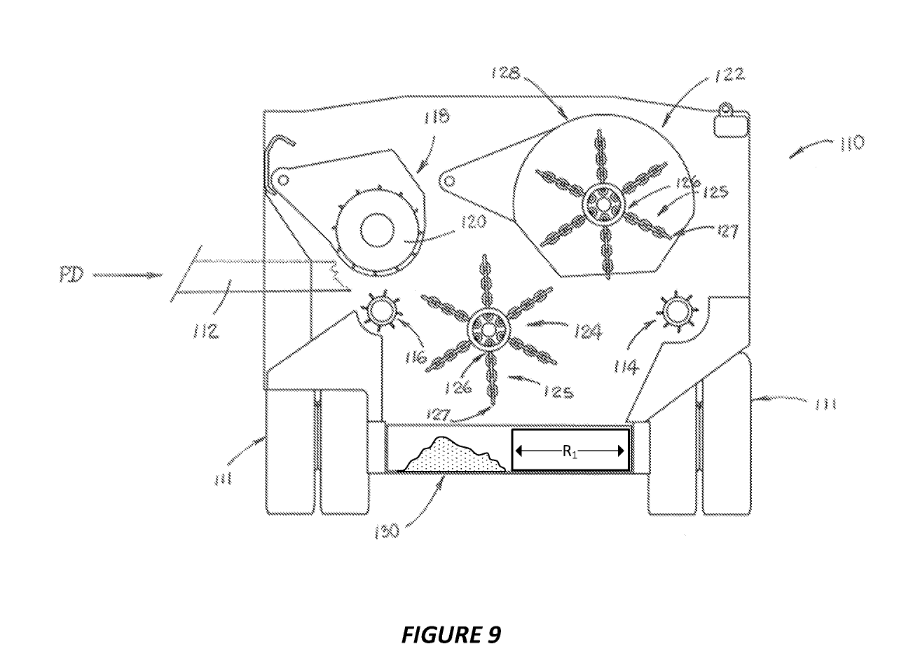

As shown in FIG. 9, in certain embodiments, the pusher apparatus 30 is configured to reciprocate in a direction R₁ over the contact surface 52 that is parallel with the processing direction D (or processing direction PD). In other embodiments, as shown in FIGS. 2 and 3, the pusher apparatus 30 is configured to reciprocate in a direction R₂ over the contact surface 52, which, in this embodiment, is perpendicular to processing direction D. As the pusher apparatus 30 reciprocates, it is configured to not only push flowable material 50 (e.g., bark) that has been deposited onto the contact surface 52 away from the machine 10 to facilitate additional processing of logs 12 but to, simultaneously therewith, also separate magnetically attracted portions, such as broken chain components 54, from the flowable material.

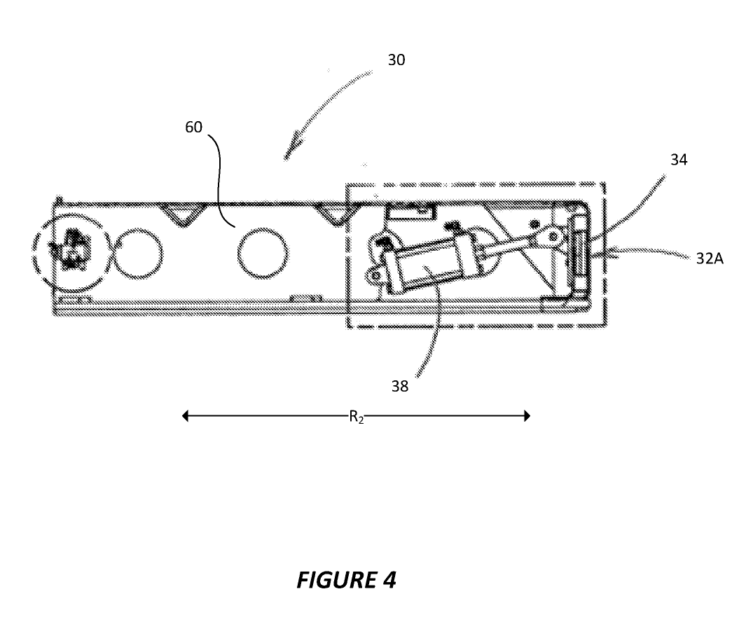

With reference to FIGS. 4-6, pusher 30 includes at least one pusher face 32A that is preferably oriented approximately perpendicularly to and is configured to slide over the contact surface 52. The pusher 30 and pusher face 32A reciprocate through the stream of flowable material 50 falling from the debarking assemblies 21, 22, and 23. Pusher face 32A is configured to push bark disposed on the contact surface 52 over the contact surface as the pusher 30 travels in a first direction (e.g., rightwards in FIG. 4).

The bark pusher 30 includes a magnet 34 that is configured to reciprocate with the pusher and pusher face 32A and that may be selectively activated and deactivated. When the magnet 34 is activated, a magnetic field is provided proximate the pusher face 32A such that magnetically attracted portions of the flowable material stream (e.g., flail chain components) that fall downwards with the non-magnetically attracted portions (e.g., bark) that are brought within the magnetic field as the pusher reciprocates are magnetically attracted to the pusher face by the magnetic field and are separated from the non-magnetically attracted portions (e.g., bark). At the appropriate time, the machine operator can deactivate the magnet 34 to enable magnetically attracted portions of the flowable material stream to fall away from the pusher face 32A.

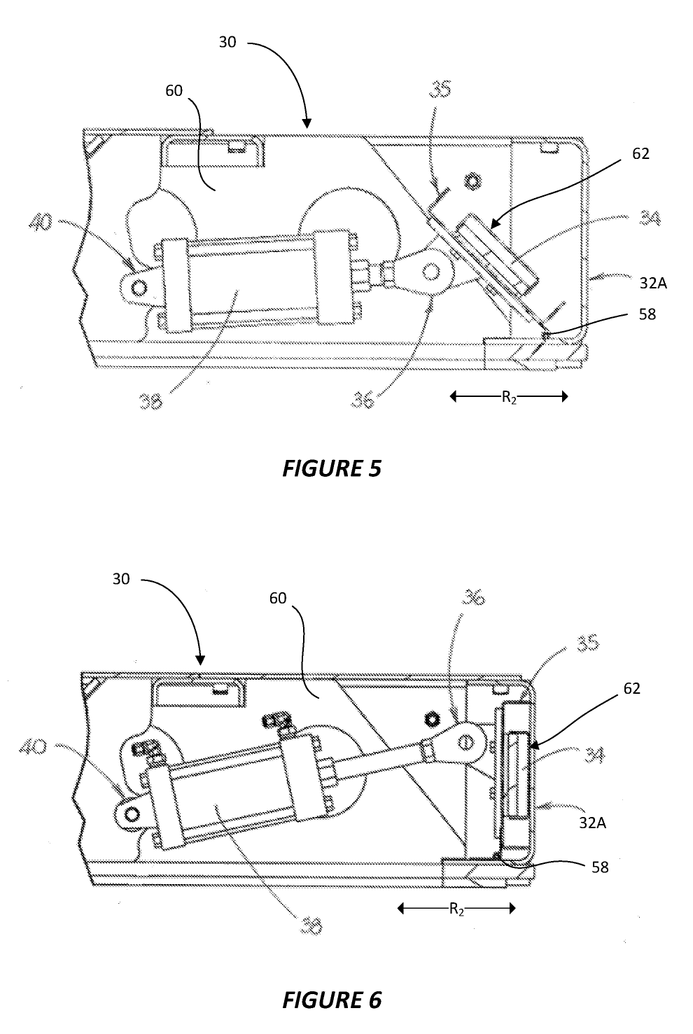

In this particular embodiment, the magnet 34 is a permanent magnet, such as a rare earth magnet. The bark pusher 30 forms an enclosure that is provided within an internal space 60. The magnet 34 is located within the internal space 60 of the bark pusher and is configured to pivot between two positions that correspond with a deactivated state and an activated state. Preferably, when the magnet 34 is activated, a face 62 of the magnet is disposed adjacent to and parallel with the pusher face 32A. More particularly, when the magnet 34 is activated, the face 62 is positioned immediately adjacent an inside surface of the pusher face 32A and opposite the flowable material 50, which is located on an outside surface of the pusher face, such that pusher face is located between the magnet and the flowable material (FIG. 6). When the magnet 34 is deactivated, at least a portion of the face 62 of the magnet is not adjacent to, is not parallel with the pusher face, or both (FIG. 5). When the magnet 34 is deactivated, the magnetic field is moved away from the pusher face 32A or the strength of the magnetic field at the pusher face 32A is sufficiently weakened that magnetically attracted portions of the flowable material 50 are no longer held against the pusher face and can be removed.

The magnet may be mounted in a bracket 35 that is mounted, via a hinge 58, to the bark pusher 30 to enable the magnet to pivot between the activated and deactivated positions. Bracket 35 is attached to a rod end 36 of a linear actuator 38. The opposite base end 40 of the linear actuator 38 is fixed to the bark pusher 30. Linear actuator 38 is adapted to move magnet 34 from a deactivated position away from the pusher face 32A (shown in FIG. 5) to an activated position adjacent to the pusher face (shown in FIG. 6). When the linear actuator 38 extends rod end 36 to move magnet 34 to the activated position, the magnetic field of the magnet will attract any chain components or other magnetically attracted items falling with the stream of flowable material 50 from the machine 10 that are within that magnetic field. Such magnetically attracted will be held fast to pusher face 32 by magnet 34 until the actuator 38 retracts rod end 36 to deactivate the magnet 34. In other embodiments, the magnet 34 is activated and deactivated by sliding the entire magnet towards and away from the pusher face 32, such as on an internal track, instead of merely pivoting. In other embodiments, the magnet 34 comprises an electromagnet that is activated by supplying an electric current, and deactivated by withdrawing such current.

Referring again to FIGS. 7 and 8, in some embodiments, pusher 30 includes a second pusher face 32B that is disposed on the pusher opposite the pusher face 32A. The second pusher face 32B is configured to push flowable material 50 deposited on the contact surface 52 over the contact surface as the pusher travels in a second direction (e.g., leftwards in FIG. 8). This configuration enables the bark pusher 30 to move flowable material 50 away from the machine 10 in two directions.

A second magnet 34 is configured to reciprocate with the pusher 30 and to be selectively activated and deactivated. As above, when the second magnet 34 is activated, a second magnetic field is provided proximate the second pusher face 32B such that magnetically attracted portions of the flowable material 50 that are brought within the second magnetic field as the pusher 30 reciprocates are magnetically attracted to the second pusher face 32B by the second magnetic field and are separated from the non-magnetically attracted portions of the flowable material. Preferably, the first and second magnets 34 may be activated and deactivated separately from one another. Again, at the appropriate time, the machine operator can deactivate the magnet 34 to enable magnetically attracted portions of the flowable material stream to fall away from the bark pusher 30.

In some embodiments, a plurality of magnets 34 is spaced along the length of the pusher face 32A. Preferably, each of these magnets 34 may be activated separately from one another in order to make certain portions of the pusher 30 magnetic while other portions are non-magnetic. In other embodiments, the magnet 34 is an electromagnet that may be selectively activated and deactivated by providing or not providing electrical current, thereby reducing the number and complexity of moving components in the bark pusher 30. To facilitate the sliding motion of the bark pusher 30, a low friction slider 56, such as an Ultra High Molecular Weight Polyethylene (UHMWPE) strip, may be provided on a bottom surface of the pusher apparatus 30 that is configured to contact and slide over the contact surface 52.

FIG. 9 illustrates debarking machine 110 that is mounted on wheel sets 111 and adapted only to debark logs 112 and does not include a chipper. The log 112 is carried through the machine 110 in processing direction PD by contact with a plurality of rotating feed rolls. Lower feed rolls 114 and 116 are mounted below the log 112 and are adapted to rotate in a clockwise direction (as shown in FIG. 9). Upper feed roll assembly 118 is pivotally mounted on the frame of machine 110 above the log 112 and is adapted to rotate feed roll 120 in a counter-clockwise direction (as shown in FIG. 9). Lower feed rolls 114 and 116 cooperate with upper feed roll assembly 118 to move log 112 into contact with upper debarking assembly 122 and lower debarking assembly 124. Each of the debarking assemblies 122, 124 includes a rotating shaft to which are attached a plurality of flail chains 125. Each rotating shaft rotates flail chains 125 about an axis of rotation that is perpendicular to direction PD. Each flail chain 125 is comprised of a plurality of interconnected links and has a fixed end 126 that is attached to a shaft and a free end 127 opposite the fixed end. Rotation of the shafts causes the chains 125 to flail the bark from the log 112. The shaft of upper debarking assembly 122 rotates in a counter-clockwise direction (as shown in FIG. 9), while the shaft of lower debarking assembly 124 rotates in a clockwise direction. Upper debarking assembly 122 includes housing 128 that is pivotally mounted to the frame of machine 110. The bark that is removed by the flail assembly falls past bark pusher 130 that reciprocates in direction R₁ that is parallel with direction PD to disperse the bark away from machine 110.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. An apparatus for use in debarking logs comprising:
a debarking assembly for separating bark from logs as the logs are passed through the apparatus, such that the separated bark falls away from the logs;
a contact surface for catching falling bark that has been separated from logs by the debarking assembly;
a pusher configured to reciprocate over said contact surface;
a first pusher face disposed on the pusher that is configured to push bark disposed on the contact surface over the contact surface as the pusher travels in a first direction; and
a first magnet configured to reciprocate with the pusher and that may be selectively activated and deactivated,
wherein, when the first magnet is activated, a magnetic field is provided proximate the first pusher face such that magnetically attracted portions included with the bark that are brought within the magnetic field as the pusher reciprocates are magnetically attracted to the first pusher face by the magnetic field and are separated from the bark.

2. The apparatus of claim 1 further comprising:
a second pusher face, disposed on the pusher opposite the first pusher face, configured to push bark disposed on the contact surface over the contact surface as the pusher travels in a second direction;
a second magnet configured to reciprocate with the pusher and that may be selectively activated and deactivated,
wherein, when the second magnet is activated, a magnetic field is provided proximate the second pusher face such that magnetically attracted portions included with the bark that are brought within the magnetic field as the pusher reciprocates are magnetically attracted to the second pusher face by the magnetic field and are separated from the bark.

3. The apparatus of claim 2 wherein the first and second magnets may activated and deactivated independently of one another.

4. The apparatus of claim 1 wherein the first magnet is a permanent magnet.

5. The apparatus of claim 1 wherein the first magnet is an electromagnet.

6. The apparatus of claim 1 wherein the first magnet is disposed adjacent the first pusher face opposite the falling bark such that the first pusher face is located between the first magnet and the falling bark.

7. The apparatus of claim 1 wherein:
when activated, a face of the first magnet is disposed adjacent to and is parallel with the first pusher face such that the magnetic field holds magnetically attracted portions against the first pusher face; and
when deactivated, at least a portion of the face of the first magnet is not adjacent to and is not parallel with the first pusher face and magnetically attracted portions are not held against the first pusher face

8. The apparatus of claim 7 wherein the magnet is pivotally mounted adjacent the first pusher face, whereby the first magnet is deactivated by pivoting away from the first pusher face.

9. The apparatus of claim 8 further comprising:
a hinge operatively mounted to the first magnet for enabling the first magnet to pivot between the activated and deactivated position;
a linear actuator for pivoting the first magnet about the hinge.

10. The apparatus of claim 1 wherein the first magnet comprises a plurality of magnets disposed along the length of the first pusher face.

11. The apparatus of claim 10 wherein each of the plurality of magnets may be activated and deactivated independently from one another.

12. The apparatus of claim 1 further comprising a low-friction slider disposed on a bottom surface of the pusher and configured to slide over the contact surface as the pusher reciprocates.

13. The apparatus of claim 1 wherein the first pusher face is approximately perpendicular to the contact surface.

14. The apparatus of claim 1 further comprising an enclosure, wherein the first pusher face is located on a side surface of the enclosure and wherein the magnet is disposed within an internal space located within the enclosure.

15. The apparatus of claim 1 wherein the debarking assembly is a flail assembly having at least one flail and wherein at least a portion of the magnetically attracted portions comprises broken away portions of the at least one flail that have fallen with the separated bark onto the contact surface.

16. The apparatus of claim 1 wherein the apparatus is configured to process logs in a processing direction D and wherein the pusher reciprocates over said contact surface in a direction R₁ that is substantially parallel with processing direction D.

17. The apparatus of claim 1 wherein the apparatus is configured to process logs in a processing direction D and wherein the pusher reciprocates over said contact surface in a direction R₂ that is substantially perpendicular to processing direction D.

18. The apparatus of claim 1 further comprising a log chipping machine that processes logs into chips after the logs have passed through the debarking assembly.

19. A method of debarking logs comprising the steps of:
A. providing a debarking assembly and passing logs through the debarking assembly to separate bark from the logs such that the separated bark falls downwards from the logs and debarking assembly;
B. providing a contact surface beneath the debarking assembly and catching falling bark with the contact surface;
C. providing a reciprocating pusher having a first pusher face and a first magnet that may be selectively activated and deactivated;
D. activating the first magnet to provide a magnetic field proximate the first pusher face;
E. reciprocating the pusher in a first direction over the contact surface such that the first pusher face pushes bark located on the contact surface;
F. attracting magnetically attracted portions including with the bark that are brought within the magnetic field away from the bark and to the first pusher face as the pusher reciprocates; and
G. deactivating the first magnet to separate magnetically attracted portions from the first pusher face.

20. The method of claim 19 further comprising the steps of:
H. providing a second pusher face, located opposite the first pusher face, and a second magnet that may be selectively activated and deactivated;
I. reciprocating the pusher in a second direction over the contact surface such that the second pusher face pushes bark located on the contact surface;
J. attracting magnetically attracted portions included with the bark that are brought within the magnetic field away from the bark and to the second pusher face as the pusher reciprocates; and
K. deactivating the second magnet to separate magnetically attracted portions from the second pusher face.
